(19) United States
(12) Patent Application Publication
(10) Pub. No.: US 2006/0240992 A1
(43) Pub. Date: Oct. 26, 2006

(54) Device having a structural element with magnetic properties, and method

(76) Inventors: Martin S. Brandt, Garching (DE); Sebastian T.B. Goennenwein, Garching (DE); Tobias Graf, Neubiberg (DE); Thomas Wassner, Siegsdorf (DE); Hans Huebl, Muenchen (DE)

Correspondence Address: SLATER & MATSIL LLP, 17950 PRESTON ROAD, SUITE 1000, DALLAS, TX, 75252, US

(21) Appl. No.: 11/334,796

(22) Filed: Jan. 18, 2006

Related U.S. Application Data
(63) Continuation of application No. PCT/DE04/01559, filed on Jul. 19, 2004.

(30) Foreign Application Priority Data
Jul. 18, 2003 (DE) 103 32 826.2

(51) Int. Cl. G01N 31/00

(52) U.S. Cl. 505/844

(57) ABSTRACT

A preferred embodiment of the invention provides a device having a structural element, which has magnetic properties that are dependent on the hydrogen content in the structural element, the structural element containing hydrogen. In a preferred embodiment, the magnetic properties of a material are altered by the introduction of hydrogen, for example in order to convert an otherwise ferromagnetic material into a paramagnetic material. For example, in a structural element made from a ferromagnetic base material, a first region can be converted with the aid of hydrogen into a paramagnetic region which adjoins a second, hydrogen-free region. This makes it possible to fabricate magnetic heterostructures from a single base material without it being necessary to alter the geometric dimensions of the structural element, for example by lithographic structuring and subsequent etching.

This application is a continuation of co-pending International Application No. PCT/DE2004,001559, filed Jul. 19, 2004, which designated the United States and was not published in English, and which is based on German Application No. 103 32 826.2 filed Jul. 18, 2003, both of which applications are incorporated herein by reference.

### TECHNICAL FIELD

The present invention relates generally to magnetic structures and methods, and more particularly to a device having a structural element with magnetic properties, and method.

### BACKGROUND

Magnetic semiconductors form important parts of modern components used in magnetoelectronics or spintronics since they provide spin-polarized charge carriers. Important examples of components that are based on utilizing spin degrees of freedom, include magnetic random access memories (MRAMs), magnetic field sensors, light-emitting diodes and lasers, which emit circular-polarized light, spin transistors and components, which are used to realize quantum-logic gates. In components of this type, the transport of charge carriers is preferably altered by varying the magnetization of individual layers, by varying the spin-polarized density of states, by varying the spin-dependent scatter at interfaces or by internal or external magnetic or electrical fields, which are applied, for example by means of gate electrodes. These effects are collectively known as magnetoresistive effects (MR or XMR for short). A distinction is drawn, inter alia, between changes to the charge carrier transport, due to spin-dependent scattering (giant magnetoresistance, GMR) and due to tunneling processes between ferromagnets with different spin-polarized density of states (tunneling magnetoresistance, TMR). Unlike ferromagnetic metals, the use of magnetic semiconductors in such components has the particular advantage that the magnetic properties can be electrically switchable by gate electrodes, see for example, A. Waag et al., Journal of Superconductivity 14, 291 (2001), which is incorporated herein by reference.

In conventional semiconductors such as Si, Ge, GaAs or ZnSe, all electron shells are completely filled; the materials are diamagnetic. Other magnetic properties can be generated by the introduction of special atoms with unsaturated electron shells. Atoms of the transition metals or of the rare earths are preferably used for this purpose, since, according to Hund's rule, high spin states are formed in their unsaturated d-shells or f-shells. With low concentrations of such atoms with unsaturated shells in semiconductors, paramagnetic behavior results. At higher concentrations, interactions occur between the magnetic moments, so that semimagnetic behavior (characterized by a high magnetic susceptibility but without the formation of a spontaneous magnetic order) or ferromagnetic behavior is established.

The preferred atom for producing ferromagnetic semiconductors is Mn. In its oxidation state 2+, Mn has an electron spin of S=5/2. This is the highest electron spin that can be achieved in transition metal atoms according to Hund's rule. Mn is used to generate ferromagnetism both in elemental semiconductors, such as Ge, in III-V compound semiconductors, for example GaAs and also in II-VI compound semiconductors such as, for example, ZnTe (Y. D. Park, et al., Science 295, 651 (2002), T. Dietl, et al., Phys. Rev. B 63, 195205 (2001) and D. Ferrand, et al., Phys. Rev. B 63, 085201 (2001), all of which are incorporated herein by reference).

In addition to the localized magnetic moments, a sufficiently strong magnetic interaction between them is required to generate ferromagnetism. In semiconductors, this interaction can be imparted by electronic charge carriers (electrons or holes) if they are likewise present in sufficient concentration in the material. The precise magnetic properties of the semiconductors are dependent to a significant degree on the concentration of the charge carriers. The required charge carriers can be produced in various ways, for example by the introduced transition metal or rare earth atoms themselves, if they have electronic states in a band of the semiconductor, or if they form donor or acceptor states in the vicinity of the band edges, (such as for example Mn in GaAs) or by co-doping with other atoms that act as donors or acceptors (such as for example N in ZnTe:Mn).

In connection with conventional doped semiconductors, it is known that the electronic effects of doping atoms can be influenced by the introduction of hydrogen. For example, in many cases, the doping can be completely reversed; the charge carrier concentration decreases drastically as a result of the introduction of hydrogen. In most cases, this happens as a result of the formation of complexes of the doping atom with hydrogen, which are no longer electronically active. This situation is referred to as passivation of the donors or acceptors. For Zn acceptors in GaAs, this is discussed inter alia in M. Stutzmann, et al., Appl. Phys. A 53, 47 (1991), which is incorporated herein by reference.

Hydrogen, however, may also occur in isolation in semiconductors and then itself forms electronically active acceptor or donor states (C. van de Walle, et al., Nature 423, 626 (2003), which is incorporated herein by reference), which lead to the formation of free charge carriers. These acceptor or donor states of hydrogen may, however, also lead to a reduction in the concentration of free charge carriers as a result of what is known as compensation for other acceptors or donors.

In the present context, the term semiconductors also encompasses materials that are semiconducting without the introduction of transition metal, rare earth or doping atoms but become metallically conductive as a result of the introduction of such atoms.

### SUMMARY OF THE INVENTION

Preferred embodiments of the present invention fundamentally widen the technical options for influencing magnetic properties of materials, in particular of solids. In particular, a device is provided having a structural element that contains a base material whereof the magnetic properties can be altered compared to the conventionally known magnetic behavior of the same base material. Furthermore, a basic method is provided allowing the magnetic properties of materials, in particular of solids, to be significantly altered, by which, for example, phase transitions of the magnetic state of a material can be achieved.

In a preferred embodiment, a device is provided having a structural element that has magnetic properties that are dependent on the hydrogen content in the structural element, the structural element containing hydrogen.

According to a preferred embodiment of the invention, a structural element is provided made from a material that has magnetic properties, i.e., which is not only diamagnetic but rather its diamagnetism has superimposed on it at least one further, stronger manifestation of magnetism, for example ferromagnetism or antiferromagnetism, paramagnetism, ferrimagnetism, or any other magnetic manifestation.

According to a further preferred embodiment of the invention, a magnetic material whose magnetic properties depend on the hydrogen content in this material is selected for the structural element. Hitherto, these dependent relationships between magnetic properties and the hydrogen content have not been exploited at a technical level; the magnetic properties of a solid are usually set by the complex production and targeted mixing of extremely complex metal-containing compounds. According to a preferred embodiment of the invention, however, it has been established that if the magnetic material is appropriately selected, a small hydrogen content that is introduced into the solid can drastically alter the magnetic behavior. For example, in a magnetic semiconductor with limited electrical conductivity at room temperature, not only the electrical properties but also the magnetic properties can be altered by the introduction of hydrogen.

Finally, according to a preferred embodiment of the invention, a suitable base material is provided with hydrogen. The hydrogen content causes the magnetic behavior of the main constituent from which the structural element is substantially formed to be different than the conventionally known magnetic behavior of the same main constituent. By way of example, a material that is actually ferromagnetic can be converted into a paramagnetic material by the introduction of hydrogen. Other phase transitions can also be achieved with the aid of adding hydrogen.

According to a preferred embodiment of the invention, the hydrogen can be introduced in any form, for example in the form of atomic particles, of radicals, of ions or of hydrogen-containing molecules that release hydrogen when they come into contact with the base material. Furthermore, it is possible to use all isotopes of hydrogen, for example including deuterium, to alter the magnetic properties. Furthermore, according to a preferred embodiment of the invention, it is also appropriate in particular to introduce hydrogen in initially molecular form, in ionic form or in the form of a radical, although this list is not conclusive. The only crucial factor is that hydrogen particles that alter the magnetic properties of the base material be formed in the base material into which the hydrogen is introduced. An alteration of this nature may, in particular, be a magnetic phase transition, in which the presence of a defined magnetic phase is dependent on the presence and concentration of the hydrogen. Furthermore, transition parameters between different magnetic phases can be altered by the hydrogen content. Therefore, preferred embodiments of the invention for the first time make technical use of the fact that adding hydrogen to a material, preferably a solid, alters not only its electrical properties but also its magnetic properties.

The subject matter of preferred embodiments of the invention also encompass semiconductors whereof the magnetic properties are altered with the aid of hydrogen, methods for manipulating the magnetic properties by means of hydrogen and components in which semiconductors whereof the magnetic properties have been altered by hydrogen are used.

Preferred embodiments of the invention allow a large number of problems involved in using semi-magnetic or ferromagnetic semiconductor layers to be solved in an advantageous way. By the targeted, and if appropriate different laterally and in the depth of the layers, introduction of hydrogen, it is possible to influence the magnetic properties of such layers after growth, for example in order to compensate for the presence of inhomogeneities or in order to magnetically structure the films and produce magnetoelectronic components. One particular advantage of preferred embodiments of the present invention is that only one semiconductor material is required to produce magnetic/nonmagnetic heterostructures, and, therefore, significantly lower defect densities occur at the interfaces of the heterostructure than if different materials, such as for example metals and oxides, are used to realize corresponding heterostructures.

One problem of ferromagnetic materials that is advantageously solved by preferred embodiments of the present invention is the lateral structuring of their magnetic properties. This is usually achieved by etching the layers by means of wet-chemical or ion-assisted methods. However, this produces a new surface structure (surface corrugation) and defects in a high concentration as well as stresses. The introduction of hydrogen, by contrast, allows the magnetic properties to be structured with a high lateral resolution without altering the surface topography. It is in this way possible to produce nanomagnets (e.g., magnetic quantum dots or quantum wires) in a structurally homogeneous layer with minimal internal stresses. The surface remains smooth, so that further films can be grown on the layer, which has only been magnetically structured without the need for additional planarization steps.

Another problem with ferromagnetic semiconductors, which is likewise solved in an advantageous way by preferred embodiments of the present invention, is the fact that the growth of the magnetic layers fixedly predetermines a magnetic anisotropy that is difficult to alter by etching structures. However, the magnetic anisotropy can be controlled with a very high level of accuracy by setting the concentration of the charge carriers and can, therefore, be altered by suitable treatment with hydrogen, even after the layer growth. The laterally different introduction of hydrogen then also allows the implementation of lateral anisotropy superlattices.

Furthermore, preferred embodiments of the invention can be used to produce further new types of magnetic and magnetic/nonmagnetic heterostructures and components. The Curie temperature of the magnetic transition can be altered by the charge carrier concentration. An inhomogeneous distribution of hydrogen can, therefore, be utilized to produce regions with different Curie temperatures and, therefore, to produce heterostructures made from different ferromagnetic materials. If hydrogen is introduced with a concentration gradient, it is possible to produce a material with gradients in its magnetic properties. If a sufficient amount of hydrogen is introduced, so that the ferromagnetism is completely destroyed in a region, the result is heterostructures comprising ferromagnetic and nonmagnetic layers. By accurately setting the hydrogen concentration introduced, it is also possible to set the electrical conductivity of the nonmagnetic parts over a wide range. In particular, in addition to magnetic structuring, it is also possible to achieve electrical structuring in this way. Adjacent magnetic regions can thus be connected to one another by semiconducting regions or separated from one another by insulating regions. Unlike corresponding structures as conventionally used in magnetoelectronics or spintronics, the structures obtained can be produced using just one materials system, such as for example GaAs:Mn. The resulting low-defect interfaces between the magnetic regions and the insulating regions have a positive effect on the properties of these components.

Various methods are suitable for manipulating the magnetic properties of semiconductors by means of hydrogen. In this context, it is preferable to use methods in which the semiconductors are exposed to atomic hydrogen or hydrogen ions. This may take place as early as during the growth of the semiconductor or alternatively after the semiconductor has been produced. Molecular hydrogen can be decomposed inter alia by means of DC or AC plasmas, by means of contact with hot surfaces or catalytically at metals such as for example palladium. For hydrogen to be introduced into a semiconductor after the latter has been produced, it is preferable to use a plasma discharge, in which case the semiconductor to be treated is advantageously not located directly in the plasma. It is particularly preferable to use a DC plasma, for example at a discharge voltage of 1000 V and an electrode-to-electrode distance of 5 cm. To extract hydrogen ions from the plasma, it is advantageous to apply a negative voltage, preferably of over 50 V, to the holder for the semiconductors.

A lateral variation in the concentration of hydrogen that is introduced into the material can be achieved for example with the aid of masks, which either locally prevent diffusion of hydrogen or lead to local dissociation of hydrogen (e.g., when using palladium as gate electrode in FIG. 2), or by using focused H ion beams. A variation in the hydrogen concentration over the depth of the layer can be achieved, for example, by means of the duration of the treatment, e.g., with a plasma or by implantation of hydrogen at defined ion energies.

To increase the diffusion of hydrogen in the semiconductor and to improve the formation of complexes, it is expedient for the semiconductor to be heated during the hydrogen treatment. For the passivation of GaAs:Mn with hydrogen, it is preferable to use a temperature of from about 100 to about 300° C., particularly preferably a temperature of from about 150 to about 200° C.

In addition to hydrogen, deuterium can also advantageously be used for the methods, semiconductors and components described here since complexes with deuterium may be more stable than the corresponding complexes with hydrogen. Therefore, in the above text the term hydrogen encompasses all isotopes of hydrogen.

It is preferably provided that the structural element contains a base material that is formed predominantly from a ferromagnetic constituent, and that the base material is paramagnetic at least in a first region on account of the hydrogen content. Conversely, it is also possible for the base material to be paramagnetic and for a region provided with hydrogen to be converted into a ferromagnetic material. An example of a ferromagnetic base material is manganese-doped gallium arsenide, which becomes paramagnetic when hydrogen is added. As a result of the addition of hydrogen, the Curie temperature and the spontaneous magnetization of the material of the structural element also change. The base material of the structural element is preferably electrically insulating or semiconducting. In the latter case, the electrical conductivity can be varied considerably by means of the hydrogen content. In particular, the electrical conductivity of the structural element can be varied in three dimensions by using an inhomogeneous distribution of the hydrogen.

The hydrogen may be present in the structural element in the form of atomic or ionic hydrogen, for example including the deuterium isotope. Furthermore, the hydrogen may be present in the form of complexes with atoms of transition metals or of rare earths. The hydrogen is preferably used to passivate some of the free charge carriers that are present in the structural element and thereby to alter the magnetic properties of the structural element. In terms of its external geometric shape, the structural element may be a homogeneous layer or a structured layer. It may also be a layer of a layer sequence arranged on a substrate. Besides its external three-dimensional configuration, the structural element may also have an inhomogeneous magnetic structure, which is produced by the three-dimensionally varying concentration of hydrogen and cannot be readily recognized from the outside. In particular, the entire structural element may be formed from a uniform base material that is provided with hydrogen only in first regions. Therefore, the magnetic properties are altered in the first regions.

The hydrogen in the structural element may be inhomogeneously distributed in the lateral direction parallel to a main face of the structural element. The hydrogen content may also be inhomogeneous in a vertical direction perpendicular to the main face of the structural element. It is also possible for the hydrogen to be concentrated and restricted to a small depth region within the extent of the depth of the structural element.

It is preferably provided that the hydrogen is arranged predominantly in a first region of the structural element and that the structural element also has a second region, the hydrogen content of which is lower than the hydrogen content in the first region. The second region of the structural element is preferably free of hydrogen. By contrast, hydrogen is present in the first region. According to the invention, the hydrogen content is a deliberately introduced hydrogen content that has been introduced with the aid of a controlled introduction method in order to alter the magnetic properties of the material of the structural element. Unintentional or inevitable impurities in the magnetic material, which on account of extremely small traces of hydrogen have no significant technical effect on the magnetic properties and are present only as traces of impurities, are, therefore, not to be considered as a deliberately introduced hydrogen content in the sense of the present invention.

The first region and the second region may each be layers or layer regions of a heterostructure. It is preferable for the second region to adjoin the first region. The first region may in particular be arranged between two second regions with a lower or negligible hydrogen content. It is preferable for the second region to be ferromagnetic and the first region to be paramagnetic on account of the hydrogen content.

A particularly preferred embodiment provides that the first region and the second region contain the same base material and that the first region additionally contains hydrogen. By contrast the second region is virtually free of hydrogen. One of a plurality of second regions may adjoin a layer made from a different base material than the base material of the structural element, for example a ferromagnetic layer made from iron, for example. This second region, together with the layer made from the other base material, forms a heterostructure, which overall has a different magnetic behavior, for example a different coercive force, than another second region.

The first region of the structural element may adjoin an end face, for example an outer face, of the structural element and extend from there into the structural element; in the finished device, the outer face or end face may be an interface with a different material or a different structural element. One advantage of this embodiment is that the hydrogen does not have to be implanted through a region that is to be kept free of hydrogen, but rather can be formed, for example through contact between the outer face and a hydrogen-containing plasma with hydrogen.

The outer face is preferably a main face of the structural element. The structural element may be free of hydrogen over a first part of its base face running parallel to the main face. Over a second part of the base face, a first, hydrogen-containing region can extend from the main face into the structural element down to a first depth. Over a third part of the base face, the first, hydrogen-containing region can extend from the main face into the structural element down to a different, second depth. This provides a first region that contains hydrogen and has a different layer thickness over different parts of the base face of the structural element. The remaining, second regions of the structural element, which contain little, if any, hydrogen, are located between the first, hydrogen-containing regions and the base face of the structural element. In the latter, magnetic properties, for example the Curie temperature or the preferred direction of the magnetic moment, may be dependent on the respective layer thickness of the second region between the base face of the structural element and the first, hydrogen-containing region, which extends from the main face into the structural element.

In accordance with a preferred embodiment of the invention, a method for altering magnetic properties of a material comprises providing a base material that has magnetic properties which alter when hydrogen is introduced into the base material, and introducing hydrogen into the base material with the result that the magnetic properties of the base material are altered at least in a first region of the base material.

The hydrogen can be introduced into the base material of the structural element by implantation, for example exclusively within a limited depth region within the depth extent of the structural element. Alternatively, the hydrogen can be introduced into the structural element by at least one end face or outer face of the structural element being brought into contact with a hydrogen-containing plasma. In preferred embodiments of the present invention in which a part of the structural element is brought into contact with a hydrogen-containing plasma, it is also conceivable for the hydrogen to be introduced into the structural element in a different way through the corresponding outer face or end face of the structural element, preferably in such a manner that the first region, which permanently contains hydrogen, extends as far as the outer face or end face of the structural element.

A first part-face of a face (main or end face) of the structural element can be protected from contact with the hydrogen-containing plasma, for example with the aid of a mask. A second part-face of the same face of the structural element can be exposed to the hydrogen-containing plasma for a first period of time. A third part-face of the same face of the structural element can be exposed to the hydrogen-containing plasma for another period of time with a different duration, in order to form a first region with a different, for example lower layer thickness beneath the third part-face of the main face of the structural element. In addition to using lithographic and mask technology methods, it is also possible for the structural element to be structured in terms of its magnetic properties with the aid of an ion beam writer that releases hydrogen-containing particles.

It is preferable for the hydrogen to be introduced into the structural element in such a way that the hydrogen content is inhomogeneous in at least one direction within the structural element. As a result, a magnetically inhomogeneous structure is produced in the structural element. The three-dimensionally inhomogeneous structure of the magnetic properties of the structural element varies over distances that are of the same order of magnitude as the geometric dimensions of structures produced lithographically in the customary way.

It is preferable for the entire structural element to initially be made from a uniform base material that has magnetic properties. Then the magnetic properties of the base material are subsequently altered by the introduction of hydrogen in at least a first region of the structural element. In particular, in this way a base material that was originally ferromagnetic is made paramagnetic in the first regions. By way of example, manganese-doped gallium arsenide can be rendered paramagnetic by introduction of hydrogen.

It is preferably provided that the first region and the second region of the structural element together form a monolithic material, for example a monolithic, epitaxial layer, which is free of interfaces or interfacial states between the first, hydrogen-containing region and the second region. As a result, the material of the structural element can be entirely grown epitaxially, which significantly simplifies the production process. Those regions of the structural element whose magnetic behavior is to be subsequently changed can then be provided with hydrogen.

A preferred device may include a spin valve transistor, a magnetic field sensor, a magnetic memory cell or an integrated semiconductor circuit. Other conceivable applications include, for example lasers or light-emitting diodes. A preferred device may, in particular be or include a microelectronic component.

A preferred embodiment of the invention is formed by magnetic semiconductors in which the semi-magnetism or ferromagnetism is reduced or completely suppressed by hydrogen. As a result of the formation of complexes or as a result of compensation, the concentration of the charge carriers, which impart the magnetic interaction in the semiconductor, is reduced by hydrogen. This leads to a drop in the transition or Curie temperature T_{c} and/or the spontaneous magnetization even to the extent of the ferromagnetism being eliminated altogether.

In the present context, the term magnetic semiconductors encompasses in particular materials which, if they are not doped by transition metal atoms or rare earth atoms, are semiconducting. Examples of these materials include C, Si, Ge, GaAs, InAs, GaSb, ZnSe, ZnS or ZnTe. If a semiconductor of this type is degeneratively doped, i.e., if high dopant concentrations of, for example transition metal atoms or rare earth atoms are introduced into these semiconductors, the materials that have thereby been doped may still have a finite conductivity at low temperatures, which is actually characteristic of metals. Irrespective of this, in the language used in the specialist field, these materials are nonetheless referred to as magnetic or ferromagnetic semiconductors.

A preferred semiconductor whereof the magnetic properties can be altered in this way is GaAs:Mn. In this context GaAs, which has an Mn concentration of between 0.5 and 10% of the Ga atoms, is particularly preferred. GaAs:Mn is advantageously produced with the aid of molecular beam epitaxy, at substrate temperatures of from 100 to 600° C., preferably at substrate temperatures of from 220 to 280° C. Introducing hydrogen into GaAs:Mn in the same concentration as that of the Mn leads to a considerable reduction in the electrical conductivity in GaAs:Mn:H, as is illustrated in an Arrhenius diagram (see subsequent description of FIG. 1) as a function of the temperature T. At the same time, the typical ferromagnetic behavior in measurements of the magnetization M as a function of the externally applied magnetic field H disappears; GaAs:Mn:H is paramagnetic after introduction of the hydrogen, as illustrated in (see subsequent description of FIG. 2).

In generally all magnetic semiconductors in which the magnetism is imparted by charge carriers and in which the charge carrier concentration is reduced by complex formation or compensation, the ferromagnetism can be correspondingly reduced or eliminated altogether by the introduction of hydrogen. This, in particular also applies to semiconductors in which the charge carriers required for the magnetic interaction have to be provided by co-doping, as for example in Mn-doped II-VI compound semiconductors. Since the local magnetic moments of the transition metal or rare earth atoms generally remain unchanged by the hydrogen, semiconductors in which the hydrogen completely eliminates the ferromagnetism are generally paramagnetic. A weak residual interaction between the magnetic moments may, under certain circumstances, also lead to anti-ferromagnetism or ferrimagnetism in these semiconductors.

Another preferred implementation is semiconductors in which local magnetic moments are present and in which semi-magnetism or ferromagnetism is produced or increased by hydrogen. The electronically active acceptor or donor states of the isolated hydrogen in these semiconductors allows free charge carriers to be produced, which impart the interaction between the local magnetic moments and, therefore, produce or improve the magnetic properties, such as Curie temperature or spontaneous magnetization. Furthermore, an existing compensation in co-doped semiconductors can be eliminated by complex formation with hydrogen, and in this way the charge carrier concentration can be increased and the magnetic properties improved.

### BRIEF DESCRIPTION OF THE DRAWINGS

Preferred embodiments of the invention are described below with reference to FIGS. 1 to 12. In the drawing:

FIG. 1 shows an Arrhenius diagram for a hydrogen-containing magnetic material;

FIG. 2 shows a diagram for the magnetic behavior of the material from FIG. 1 with and without hydrogen content;

FIG. 3 diagrammatically depicts a device;

FIG. 4 shows a first embodiment of a device according to the invention with a structural element;

FIG. 5 diagrammatically depicts the structural element from FIG. 4 with further details relating to the internal structure of the structural element;

FIG. 6 shows a second embodiment of a device according to the invention with a structural element;

FIG. 7 shows a third embodiment of a device according to the invention with a structural element;

FIG. 8 shows a cross-sectional view through a refinement of a device according to the invention with a structural element;

FIG. 9 shows a plan view onto the structural element from FIG. 8;

FIG. 10 shows a fourth embodiment of a device according to the invention with a structural element;

FIG. 11 shows a method step used in the production of the device according to the invention from FIG. 10; and

FIG. 12 shows an alternative embodiment to FIG. 7.

| | |
|---|---|
| 1 | Device |
| 2 | Structural element |
| 10 | Substrate |
| 11 | Main face |
| 12; 12a; 12b | Second region |
| 13 | Heterostructure |
| 14; 14a; 14b | First region |
| 15 | Gate dielectric |
| 16 | Gate electrode |
| 18 | Layer |
| 20 | Spin valve transistor |
| 21 | Magnetic field sensor |
| 22, 32 | Base material |
| 23 | Magnetic memory cell |
| 24 | Depth region |
| 25 | Integrated semiconductor circuit |
| 28 | Other base material |
| 30 | Plasma |
| 34 | End face |
| 35 | Mask |
| 42 | Ferromagnetic constituent |
| 52 | Paramagnetic constituent |
| d1, d2, d3 | Layer thickness |
| G | Base face |
| H | Hydrogen |
| H′ | Magnetic field |
| I, II, III | Part of the base face |
| Ia, IIa, IIIa | Part-face |
| L | Charge carriers |
| M, M′ | Magnetization |
| σ | Electrical conductivity |
| t2 | First depth |
| t3 | Second depth |
| T | Temperature |
| Tc, Tc′ | Curie temperature |
| T2, T3 | Period of time |
| x, y | Lateral direction |
| z | Vertical direction |

### DETAILED DESCRIPTION OF ILLUSTRATIVE EMBODIMENTS

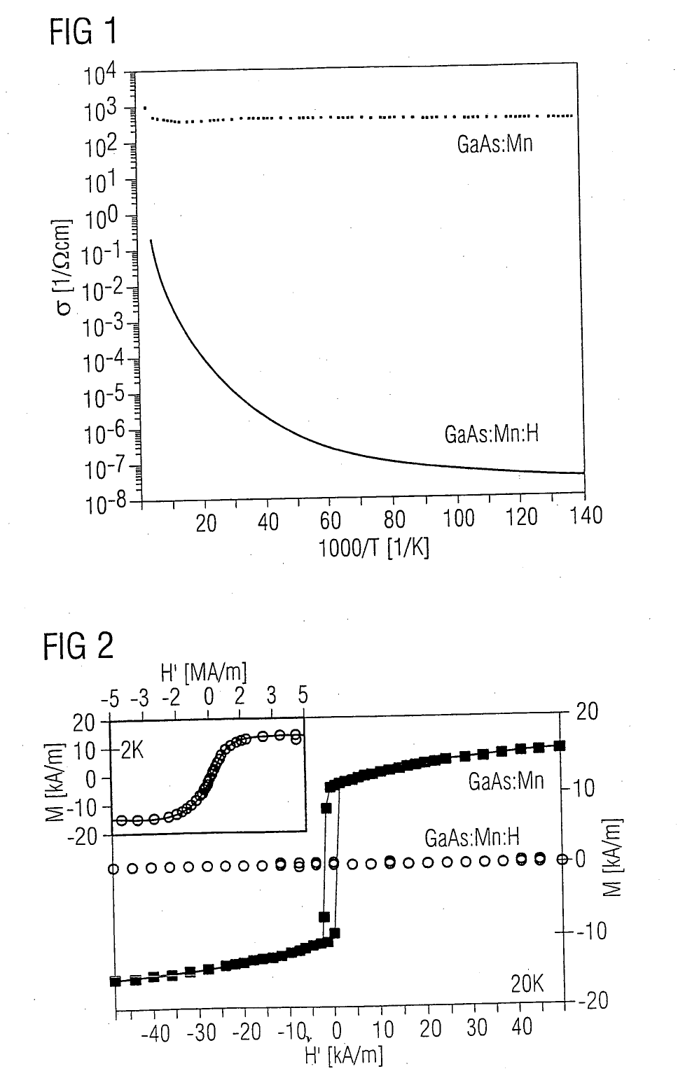

FIG. 1 shows an Arrhenius diagram in which the electrical conductivity σ is plotted as a function of the reciprocal temperature. The conductivity is plotted for manganese-doped gallium arsenide, both with (solid line) and without (dotted line) additional hydrogen content in the doped gallium arsenide. It can be seen that adding hydrogen considerably reduces the electrical conductivity.

FIG. 2 shows the way in which the magnetization M for manganese-doped gallium arsenide is dependent on an external magnetic field H′. Whereas for the hydrogen-free base material at 20 Kelvin the hysteresis curve that is typical of ferromagnetism can be recognized (black square measurement points), adding hydrogen causes the strong ferromagnetic magnetization to collapse (white circular measurement points). The sub-diagram illustrated for a temperature of 2 Kelvin shows the magnetization of the hydrogen-containing material measured with stronger magnetic fields. The typical paramagnetic behavior can be recognized; this is in particular easier to observe experimentally at very low temperatures.

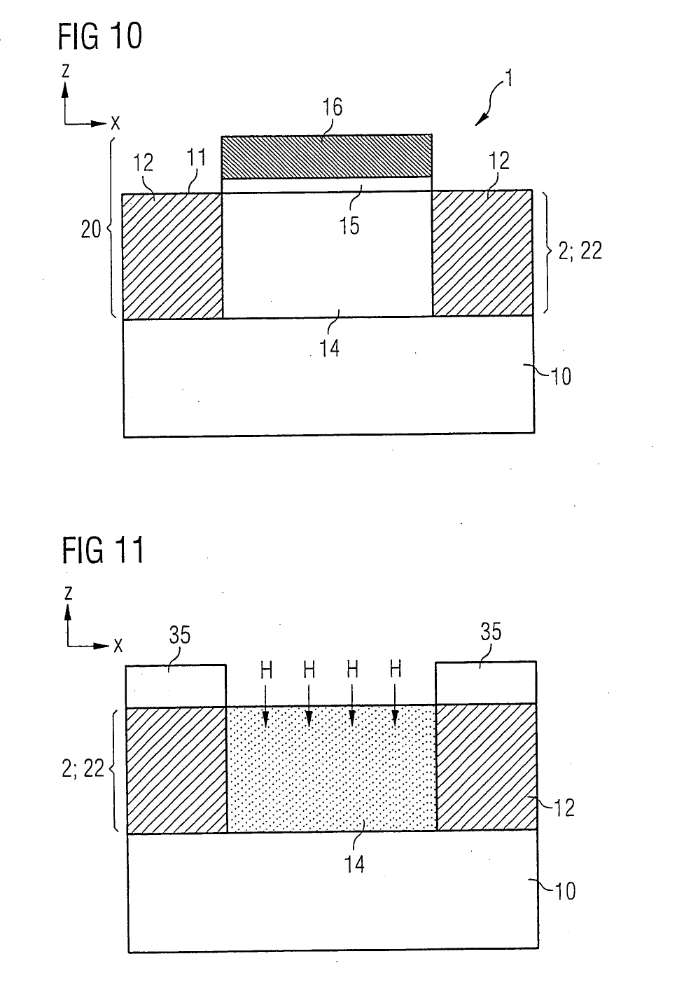

Two possible realizations of components in which the magnetic properties of a structural element are inhomogeneous because of the introduced hydrogen are diagrammatically depicted in FIGS. 4 and 10. FIG. 4 shows a vertical heterostructure, FIG. 10 a lateral heterostructure made from magnetic and nonmagnetic semiconductors. On the substrate 10 in FIG. 4 there are layers of one or various magnetic semiconductors 12. Between them is a semiconductor layer 14 in which the ferromagnetism has been destroyed by the introduction of hydrogen. It is preferable for the structures depicted to be produced by depth-inhomogeneous introduction of hydrogen into a previously homogenous ferromagnetic semiconductor layer. A configuration of the magnetic properties that is inhomogeneous in the lateral direction will also be explained with reference to FIG. 10.

Electronic transport processes through these structures can be influenced by varying the magnetization of individual layers, by varying the spin-polarized density of states of individual layers, by varying the spin-dependent scatter at interfaces between the layers, by varying the conductivity of the layers or by varying the internal or external magnetic or electric fields. Structures of this type can advantageously be used, for example as sensors for magnetic fields or as magnetic random access memories.

If necessary, these structures can be extended, for example by contact layers and supply conductors, by suitable insulating interlayers to avoid electronic transport through the substrate, by magnetically hard layers for defining magnetic preferred orientations and by other semiconductor structures or components. The layers 12 and 14 themselves may comprise a combination of different semiconductors or may have inhomogeneous dopings or inhomogeneous magnetic properties. Heterostructures comprising magnetic and nonmagnetic layers can, according to embodiments of the invention also be produced from combinations of ferromagnetic metals and semiconductors in which, as described here, the ferromagnetism has been destroyed by hydrogen, or from combinations of semiconductors in which, as described here, ferromagnetism is produced by hydrogen, and nonmagnetic materials.

A particularly preferred implementation is a component as shown in FIG. 4, in which the ferromagnetic semiconductor layers 12 consist of GaAs:Mn, with an Mn concentration of from about 0.5 to about 10%. These layers are each between about 1 and about 100 nm thick, preferably between about 20 and about 100 nm thick. Between these two layers there is a layer GaAs:Mn 14 into which hydrogen has been introduced, with the result that this layer is no longer ferromagnetic. This layer 14 is between about 0.5 and about 10 nm thick, preferably between about 1 and about 5 nm thick. It is preferable for this layer structure to be produced from a thick film of GaAs:Mn into which hydrogen is introduced at the desired depth. This is done, for example by ion implantation. Implantation with hydrogen with an acceleration voltage of the hydrogen ions of 5 keV and a hydrogen ion level of 3×10¹⁴ per cm² is preferably used to produce an insulating layer GaAs:Mn:H with a thickness of approximately 3 nm and at a depth of approximately 50 nm in GaAs:Mn comprising 5% Mn. After the implantation, the layer structure can be conditioned, for example at temperatures between about 100 and about 300° C.

To ensure switching of the two ferromagnetic layers 12 at different coercive forces, it is possible to select different layer thicknesses for them. Alternatively, it is also possible for different coercive forces to be realized by varying the Mn concentration in the two layers, preferably by a difference of at least 1% between the concentrations. It is particularly preferable for different coercive forces to be realized by the introduction of hydrogen into one of the two layers 12, by implantation or treatment in a hydrogen plasma. This treatment preferably produces a difference in the coercive forces in the two layers 12 of at least 1 kA/m, or 1% of hydrogen, based on the concentration of the Ga atoms in GaAs:Mn is introduced in at least one of the two layers 12, taken as an average over the respective layer. Alternatively, different coercive forces of the layers can also be produced by using heterostructures, as illustrated in FIG. 5. In this case, the upper ferromagnetic layer is replaced by a layer structure made up of a ferromagnetic semiconductor layer 12 and a further ferromagnetic layer 18. This layer preferably consists of GaAs:Mn with a thickness of about 50 nm, and the layer of iron has a preferred thickness of about 10 nm.

If the layer 14 in the above structures is insulating, the conductivity between the layers 12, on account of the tunneling magnetoresistance, will be dependent on the relative orientation of the magnetizations in the layers 12. If the layer 14 is metallically conductive but not ferromagnetic, the resistance of the entire layer structure, on account of giant magnetoresistance will be dependent on the relative orientation of the magnetizations in the layers 12. Both structures can be used to measure magnetic fields or can be used in magnetic random access memories.

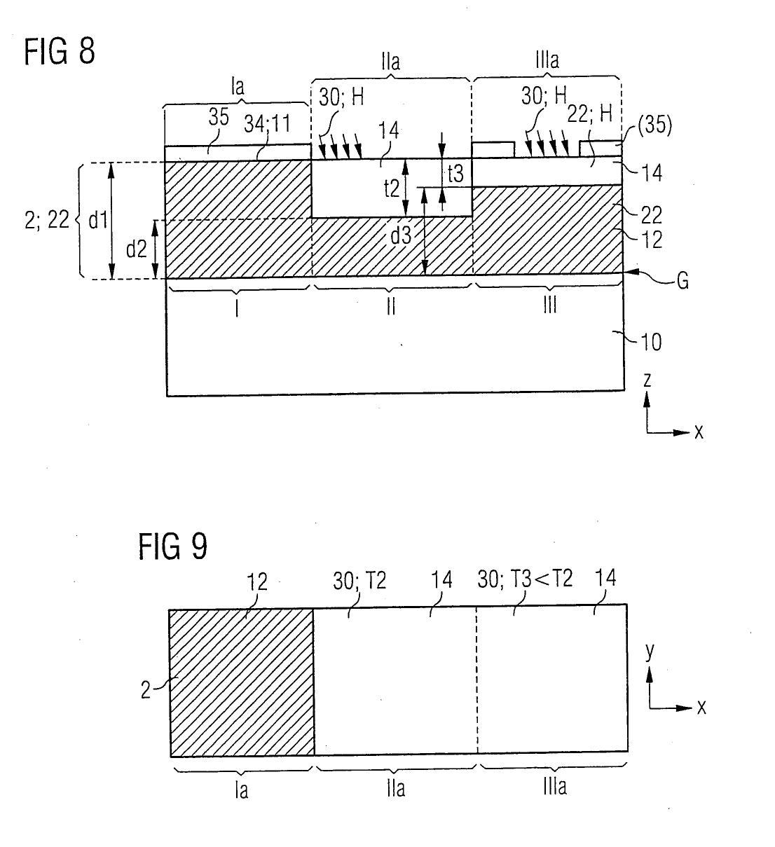

Another particularly preferred implementation is a lateral heterostructure, in which the magnetic properties of an initially magnetically homogeneous layer have been altered by introduction of hydrogen. A particularly preferred realization is a heterostructure in which hydrogen has been introduced only into some regions of the layer. The heterostructure may also include regions in which hydrogen has been introduced to different depths and/or in different concentrations. This can be achieved, for example by parts of the layer being exposed to the dc plasma described above for different lengths of time, in which case the lateral structuring can be achieved by using masks. Preferred masks that prevent hydrogen from diffusing in are thin films of gold (thickness preferably about 5-1000 nm) or SiO₂ or Si₃N₄ (thickness preferably about 50-5000 nm). It is particularly preferable to use lateral heterostructures in which the hydrogen has diffused in such a way that a non-ferromagnetic layer 14, which may be of different thicknesses, is formed locally at the surface of the originally ferromagnetic layer 12. An embodiment of this type will be explained further with reference to FIG. 8. In this context, it is preferable to realize non-ferromagnetic layer thicknesses of at least 1 nm. Lateral heterostructures in which the direction of easy magnetization is locally altered by the influence of the hydrogen are particularly preferred.

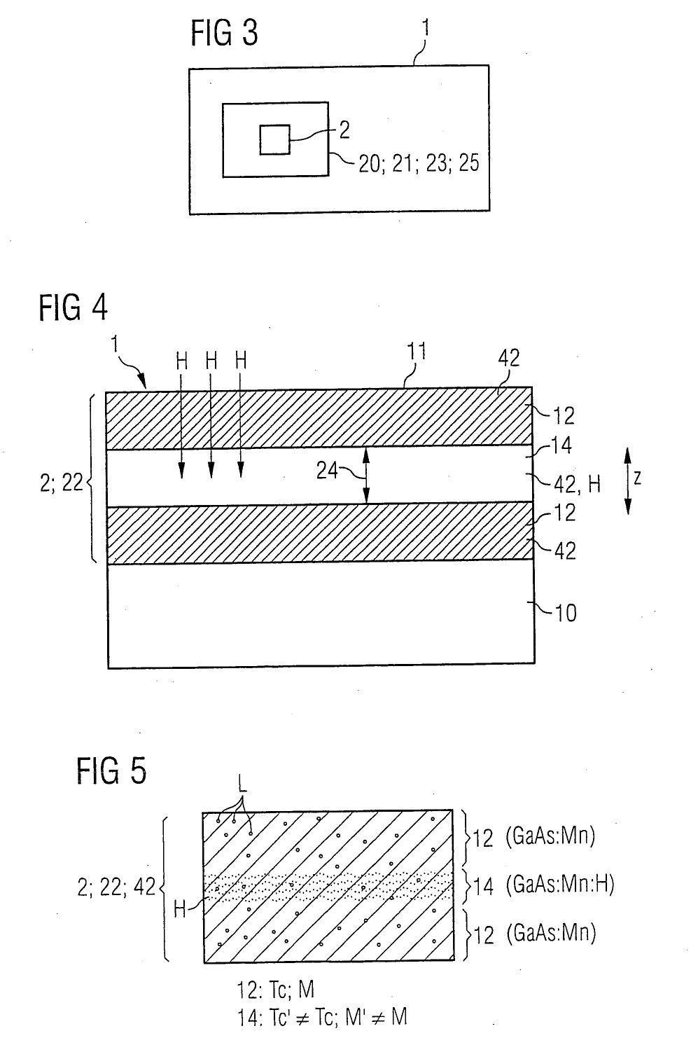

FIG. 3 diagrammatically depicts a device 1 according to embodiments of the invention that has a structural element 2 made from a magnetic material, the magnetic properties of which have been altered by the addition of hydrogen in accordance with the invention. The structural element 2 may be included within a higher-level unit, which may for example be a spin valve transistor 20, a magnetic field sensor 21, a magnetic memory cell 23 or an integrated semiconductor circuit 25. This higher-level unit may be part of the component 1. The component 1 may also itself form the higher-level unit. Further possible configurations include lasers or light-emitting diodes.

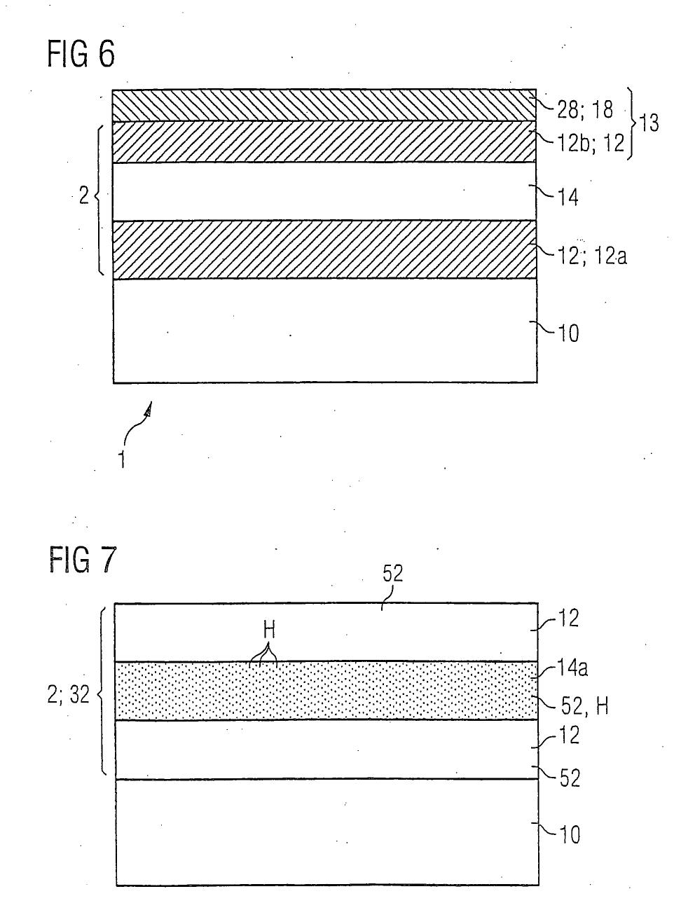

FIG. 4 shows a cross section through a first embodiment of a device 1 according to embodiments of the invention, which on a substrate 10 has a structural element 2 made from a base material 22, which is ferromagnetic in the hydrogen-free state. In a first region 14, the base material 22 additionally contains hydrogen H, which has been introduced into a middle depth region 24 by implantation following the structuring of the structural element 2, as indicated by the arrows in FIG. 4. The implantation of the hydrogen into the structural element 2 has made the latter paramagnetic in a first region 14. By contrast, in at least one second region 12, the material of the structural element 2 is still ferromagnetic. In terms of its magnetic behavior, the structural element 2 has been structured in the vertical direction z perpendicular to a main face 11 of the structural element 2. In the second regions 12, the base material 22 of the structural element 2 contains a ferromagnetic constituent 42, preferably GaAs:Mn. In the first region 14, this material has additionally been doped with hydrogen H. In the exemplary embodiment shown in FIG. 4, the hydrogen has preferably been introduced by implantation. The layer thicknesses in FIG. 4 are not to scale. Guidelines for the layer thicknesses can be found, for example in the description of FIG. 6.

FIG. 5 diagrammatically depicts the structural element 2 from FIG. 4 with further details relating to the internal structure of the base material 22. The entire structural element 2 contains a uniform base material 22, namely for example GaAs:Mn, so that no pronounced interfaces with an increased concentration of defects or other disruptive interfacial states occur within the structural element.

On account of the uniform base material, which has been grown by a single method step, in particular the boundary between the paramagnetic, first region 14 and the ferromagnetic regions 12 are free of an increased concentration of defects or other disruptive interfacial states that would lead to disruptive effects when operating the spin transistor. Increased defect concentrations, by contrast, are inevitable at metal-insulator interfaces of metal-insulator-metal heterostructures in conventional devices if the metal and insulator are produced by different process steps, for example by deposition or growth.

Charge carriers L marked by large dots are arranged in the base material 22. Hydrogen H, which is indicated by small dots, has additionally been introduced in the first region 14. The hydrogen H passivates or neutralizes some of the charge carriers L arranged in the first region 14, and thereby alters the electrical conductivity but also the magnetic behavior in the first region 14. In particular, the material 22 in the first region 14 is no longer ferromagnetic, but rather is now paramagnetic. As a result, the material of the structural element 2 has a different Curie temperature Tc′ and a different magnetization M′ in the first region 14 than in the ferromagnetic second regions 12. The material of the structural element in the first region 14 may also be paramagnetic in a temperature-independent way, i.e., may no longer have a Curie temperature.

A dopant atom, for example manganese, as acceptor withdraws an electron from the valence band of the base material and produces a hole or defect electron in the valence band of the base material. In the case of passivation of acceptors, a donor, according to embodiments of the invention hydrogen, is introduced into the base material, and the electron, which it releases into the conduction band is recombined with the defect electron. Hydrogen can, therefore, be introduced in particular as counter-doping into a base material that has already been doped (compensation). In the case of a further mechanism, complexes of the hydrogen with another dopant, for example, manganese, are formed. This is known as passivation.

FIG. 6 shows a device 1 according to the invention in accordance with a second embodiment, in which a layer 18 of a different base material 28, for example iron, has been formed over the structural element 2. Furthermore, one 12b of a plurality of second, ferromagnetic regions 12a; 12b has a different layer thickness than the other ferromagnetic region 12a. A hydrogen-containing region 14 of the structural element 2 in which the material of the structural element 2 is paramagnetic, is arranged between the two second regions 12a, 12b which are each free or substantially free of hydrogen and are, therefore, ferromagnetic. The one 12b of the two second regions, together with the layer 18 made from the other base material 18, forms a heterostructure 13 that has a different coercive force than the second region 12a arranged between the first region 14 and the substrate 10. The layer thicknesses of the regions 12 may be of the order of magnitude of about 1 to about 100 nm, preferably about 20 to about 100 nm. The hydrogen-containing gallium arsenide layer, i.e., the first region 14, which is illustrated in an exaggerated thickness, preferably has a layer thickness of between about 0.5 and about 10 nm and preferably contains a manganese content of between about 0.5 and about 10%.

FIG. 7 shows a third embodiment of a component according to the invention, in which the structural element 2 contains a base material 32 that substantially comprises a paramagnetic constituent 52. In a first region 14a, the material 32 of the structural element 2, on account of an additional hydrogen H content, is not paramagnetic, but rather is ferromagnetic.

FIG. 8 shows a refinement of a device according to embodiments of the invention, the structural element 2 of which has been produced from a preferably ferromagnetic base material 22, the magnetic properties of which are inhomogeneous on account of the introduction of hydrogen in the vertical direction z and also in the horizontal direction x. Besides its external geometric structure, the structural element 2 also has an internal, magnetic structure. A base face G has a first part I, a second part II and a third part III. On the opposite side, the structural element 2 has a main face 11, which simultaneously constitutes an end face 34, which at least in regions is exposed to a hydrogen-containing plasma 30. A first part-face Ia is protected from the hydrogen-containing plasma 30 by a mask 35, so that the entire layer thickness d1 of the structural element 2 in the region of the first part I of the base face G is ferromagnetic, i.e., is formed as second region 12. Over a second part II of the base face G, the end face 34 was temporarily exposed to a hydrogen-containing plasma 30, which has penetrated through a second part-face IIa of the end face 34 into the interior of the structural element 2. As a result, over the second region II of the base face, a first, paramagnetic region 14 of the base material 22 of the structural element 2 was formed, extending from the main face 11 of the structural element 2 into the structural element down to a first depth t2. The structural element 2 remains ferromagnetic in the region of the remaining layer thickness d2. Over a third region III of the base face G, the end face 34 of the structural element was exposed to the hydrogen-containing plasma 30 for a different, preferably shorter, period of time. This resulted in the formation of a paramagnetic first region 14 that extends from the end face 34 into the structural element 2 down to a different, in FIG. 8 lesser, second depth t3. The remaining layer thickness d3 below the first region 14 characterizes the second region 12 over the third part III of the base face G of the structural element in which the structural element remains ferromagnetic.

In manufacturing technology terms, the lower depth of penetration of the hydrogen below the third part-face IIIa of the end face 34 (and, therefore, the reduced depth t3 of the boundary between the paramagnetic first region 14 and the ferromagnetic second region 12) can be achieved by the end face 34 of the structural element 2 being temporarily exposed to the hydrogen-containing plasma 30, or alternatively by it being temporarily covered with a mask 35 as indicated in FIG. 8 by the reference numeral 35 in parentheses and the mask illustrated by double-hatching, which is thereby indicated. By way of example, it is possible first of all for a mask 35 disposed on the part-faces Ia and IIIa to be formed on the end face 34 of the structural element 2. Then, the end face 34 is brought into contact with the hydrogen-containing plasma 30, with only the second part face Ia of the end face 34 being exposed to the hydrogen-containing plasma. Then, the mask 35 is removed in the region of the third part-face IIIa, and the end face 34 of the structural element is exposed to the hydrogen-containing plasma 30 once again. In the process, the hydrogen penetrates into the structural element 2 through the part-faces IIa and IIIa. On account of the longer period of time for which the second part-face IIIa was exposed to the hydrogen-containing plasma 30, the first depth t2 of the first region 14 in the center of the structural element, i.e., above the second part II of the base face G, is greater than the depth t3 of the first, paramagnetic region 14 above the third part III of the base face G.

The device illustrated in FIG. 8 can be produced as a “Hall bar” with different layer thicknesses d1, d2, d3 of the ferromagnetic second regions 12 of the structural element 2 without the structural element 2 itself having to be structured by etching or other steps that alter the geometric shape of the structural element 2. Instead, exclusively the magnetic properties of the structural element are structured, but there is no geometry structuring. In the case of a ferromagnetic base material 22, the direction in which the spontaneous magnetization is formed most easily depends, inter alia on the layer thickness d1, d2, d3 of the ferromagnetic region 12. Other influencing factors are the charge concentration and applied electric voltages. Regions 12 of the ferromagnetic Hall bar arranged above different parts I, II, III of the base face G each have a different preferred direction of the magnetic moments of the mobile charge carriers arranged therein. If an electric voltage with a voltage gradient running perpendicular through the plane of the drawing in FIG. 8 is applied in each case over the parts I, II and III of the base face G, the electrical biasing can alter the orientation of the magnetic moment. The different setting of the orientation of the magnetic moments can be used to effect the transfer of charge carriers from a first part-volume, which is arranged between the part I of the base face G and the part-face Ia of the main face 11, into a further part-volume of layer thickness d2 above the second part II of the base face G or from there into a third part-volume of layer thickness d3 above the third part III of the base face. It is in this way possible to provide a switching element in which the transfer of the charge carriers between different part-volumes of different layer thickness d1, d2, d3 is controlled by an electrical-magnetic coupling. According to the invention, the different layer thicknesses d1, d2, d3 are produced by different penetration depths t2, t3 of the hydrogen and, therefore, by a different layer thickness of the paramagnetic first region 14 above the ferromagnetic part-volumes.

FIG. 9 shows a plan view onto the component illustrated in accordance with FIG. 8. Beneath a first part-face Ia of the end face 34, the base material of the structural element 2 is ferromagnetic (reference 12). Beneath a second part-face IIa and a third part-face IIIa of the end face illustrated in plan view, by contrast, there is arranged a paramagnetic first region 14 that extends down to a depth t2 below the second part-face IIa. It was produced by the end face being exposed to the hydrogen-containing plasma 30 for a period of time t2. The third part-face IIIa was only exposed to the plasma 30 for a shorter period of time T3, with the result that the layer thickness of the paramagnetic first region 14 is lower in the region of the part-face IIIa.

FIG. 10 shows a further embodiment of a device 1 according to the invention, in which a structural element 2, which consists of a base material 22 with a ferromagnetic main constituent, has been structured in the lateral direction x on a substrate 10. This “structuring” is not a geometric structuring of the geometric dimensions of the structural element, but rather a three-dimensional structuring of the magnetic properties of the structural element 2, for example in the lateral direction x. In particular, hydrogen has been introduced in a first region 14, which is surrounded on both sides by second regions 12, with the result that the base material 22 of the structural element 2 has become paramagnetic in the first region 14. Then, a gate dielectric 15 is deposited on the first region 14, and the gate electrode 16 is formed on the gate dielectric 15. The component 1 illustrated in FIG. 10 includes a spin valve transistor, the second regions 12 of which serve as source/drain regions that are each ferromagnetic. The first region 14, which is semiconducting and paramagnetic, contains hydrogen in addition to the base material, for example manganese-doped gallium arsenide. The entire structural element 2 was applied by a single epitaxy step and only subsequently magnetically structured. As a result, the boundary between the paramagnetic, first region 14 and the ferromagnetic regions 12 is free of an increased concentration of defects or other disruptive interfacial states that would lead to disruptive effects when the spin transistor is operating. Charge carriers which already have a defined preferred direction of their spin can penetrate from the second region arranged, for example, on the left in FIG. 10 into the semiconducting material in the first region 14, which serves as a channel region. During the charge transport within the first region, the spins precess at a velocity that is dependent on the gate voltage at the gate electrode 16. By way of example, only charge carriers whose spins have a predetermined preferred direction, for example those that face to the right, can penetrate at the boundary between the first region 14 and the second region 12 arranged on the right in FIG. 10, which is ferromagnetic, whereas charge carriers with a spin facing to the left cannot penetrate into the second region 12 arranged on the right in FIG. 10. By virtue of the orientation of the spins of the charge carriers passing through the first region 14 being controlled with the aid of the gate voltage, it is possible to switch the transistor. Therefore, the charge transport of the electrons between the two source/drain regions is promoted or blocked depending on the influencing of the spin of the electrons. As a result of the introduction of hydrogen in accordance with a preferred embodiment of the invention into an existing structural element 2 on a uniform base material 22, the above-described spin transistor can for the first time be realized by manufacturing technology, since in the case of a spin transistor whose ferromagnetic regions 12 and paramagnetic regions 14 were to be applied by different epitaxy steps and were to be separated from one another by interfaces, interfacial defects would lead to destruction of a preferred direction of the charge carrier spins on passage through the interface.

Structures as illustrated in FIG. 10 can advantageously be used, for example as sensors for magnetic fields or as magnetic random access memories. The lateral structure in FIG. 10 can also be extended, for example, by the use of an electric gate 16, to form a spin valve transistor.

FIG. 11 shows a method step used in the production of a preferred device according to the invention as shown in FIG. 10. Hydrogen H is introduced into a middle region of the base material 22 of the structural element 2 that has already been formed, preferably by the structural element 2 being exposed to a hydrogen plasma, as indicated with the aid of the arrows. Alternatively, it is also conceivable for example to use implantation. As a result, the originally ferromagnetic base material 22 of the structural element 2 becomes paramagnetic in the middle region, which is not protected by a mask 35. After the introduction of the hydrogen, a gate dielectric 15 is applied and the gate electrode 16 is formed thereon.

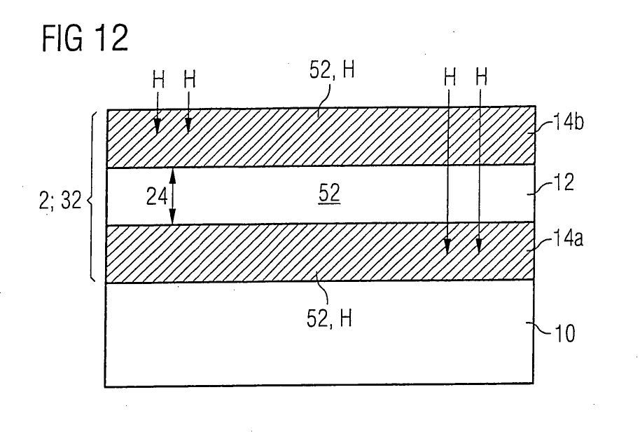

FIG. 12 shows a cross section through an alternative embodiment to FIG. 7. In accordance with FIG. 12, the structural element 2 contains a base material 32, which substantially comprises a paramagnetic constituent 52. In first regions 14a, 14b outside a depth region 24, the material 32 of the structural element 2 is no longer paramagnetic, but rather is ferromagnetic, on account of an additional hydrogen H content. The hydrogen is introduced into the regions 14a, 14b for example by two implantation steps. The embodiment shown in FIG. 12 has two ferromagnetic layers, which in practice will be formed as more complex ferromagnetic layer sequences. The embodiment shown in FIG. 12 can be used as a tunneling structure (TMR) in MRAMs.

What is claimed is:

1. A device having a structural element that has magnetic properties that are dependent on a hydrogen content in the structural element, the structural element containing the hydrogen content in the form of a hydrogen-doping, wherein the structural element contains a base material that is predominantly formed from a paramagnetic constituent, and wherein the base material is ferromagnetic at least in a first region because of the hydrogen content.

2. A device having a structural element that has magnetic properties that are dependent on a hydrogen content in the structural element, the structural element has an altered Curie temperature or an altered spontaneous magnetization because of the hydrogen content.

3. A device having a structural element that has magnetic properties that are dependent on the hydrogen content in the structural element, the structural element containing a hydrogen content in the form of a hydrogen-doping, wherein the base material of the structural element is an electrical insulator.

4. A device having a structural element that has magnetic properties that are dependent on the hydrogen content in a structural element, the structural element containing the hydrogen content in the form of a hydrogen-doping, wherein the base material of the structural element, at least in a first region, is a semiconductor whereof the electrical conductivity depends on the hydrogen content.

5. The device as claimed in claim 4, wherein the electrical conductivity of the structural element varies spatially in the structural element as a function of the hydrogen content.

6. The device as claimed in claim 4, wherein the hydrogen in the structural element is in the form of atomic or ionic hydrogen, including deuterium.

7. The device as claimed in claim 4, wherein the hydrogen in the structural element is in the form of complexes with atoms of a transition metal or of a rare earth.

8. The device as claimed in claim 4, wherein free charge carriers are present in the structural element and in that some of the free charge carriers are passivated by the hydrogen content.

9. The device as claimed in claim 4, wherein the electrical conductivity in the first region of the structural element is reduced by the hydrogen content.

10. The device as claimed in claim 4, wherein the base material of the structural element predominantly contains gallium arsenide.

11. The device as claimed in claim 4, wherein the structural element is doped with manganese.

12. The device as claimed in claim 4, wherein the structural element is a layer arranged on a substrate.

13. The device as claimed in claim 4, wherein the structural element is a layer of a patterned stack of layers arranged on a substrate.

14. The device as claimed in claim 4, wherein the hydrogen content in the structural element is inhomogeneously distributed in at least one direction parallel to a main face of the structural element.

15. The device as claimed in claim 4, wherein the hydrogen content in the structural element is inhomogeneous in a direction that is perpendicular with respect to a main face of the structural element.

16. The device as claimed in claim 4, wherein the hydrogen is arranged in a limited depth region within the structural element.

17. The device as claimed in claim 4, wherein the hydrogen is arranged predominantly in a first region of the structural element, and in that the structural element also has a second region, the hydrogen content of which is lower than the hydrogen content in the first region.

18. The device as claimed in claim 17, wherein the hydrogen that is present in the structural element is arranged in the first region of the structural element.

19. The device as claimed in claim 17, wherein the first region and the second region are each layers or layer regions of a heterostructure.

20. The device as claimed in claim 17, wherein the second region adjoins the first region.

21. The device as claimed in claim 17, wherein the first region is arranged between two second regions which are substantially free of hydrogen.

22. The device as claimed in claim 21, wherein one of the two second regions adjoins a layer of a different base material than the base material of the structural element, and in that this one of the two second regions and the layer of the other base material form a ferromagnetic heterostructure.

23. The device as claimed in claim 17, wherein the second region is ferromagnetic, and the first region is paramagnetic on account of the hydrogen content.

24. The device as claimed in claim 17, wherein the first region and the second region contain the same base material, and in that the first region additionally contains hydrogen.

25. The device as claimed in claim 4, wherein the device includes a spin valve transistor, a magnetic field sensor, a magnetic memory cell or an integrated semiconductor circuit.

26. The device as claimed in claim 25, wherein the structural element is arranged in the spin valve transistor, the magnetic field sensor, the magnetic memory cell or the integrated semiconductor circuit.

27. The device as claimed in claim 4, wherein the device is a microelectronic component.

28. The device as claimed in claim 4, wherein the first region adjoins an end face of the structural element and extends from the end face into the structural element.

29. The device as claimed in claim 28, wherein the end face is a main face of the structural element.

30. The device as claimed in claim 4, wherein the structural element is free of hydrogen over a first part of a base face of the structural element.

31. The device as claimed in claim 30, wherein over a second part of the base face of the structural element, the first region extends from the end face into the structural element down to a first depth.

32. The device as claimed in claim 31, wherein over a third part of the base face of the structural element, the first region extends from the end face into the structural element down to a second depth, which is different than the first depth.

33. The device as claimed in claim 32, wherein the second subregion in each case has a different layer thickness over the first, second and third part of the base face of the structural element.

34. A method for altering magnetic properties of a material, the method comprising:
providing a base material that has magnetic properties which alter when hydrogen is introduced into the base material; and
introducing a doping of hydrogen into the base material, wherein the magnetic properties of the base material are altered at least in a first region of the base material;
the base material being formed predominantly from a paramagnetic constituent and becoming ferromagnetic at least in a first region from the introduction of hydrogen.

35. A method for altering magnetic properties of a material, the method comprising:
providing a base material that has magnetic properties which alter when hydrogen is introduced into the base material; and
introducing a doping of hydrogen into the base material, wherein the magnetic properties of the base material are altered at least in a first region of the base material;
the base material having an altered Curie temperature or an altered spontaneous magnetization because of the hydrogen content.

36. The method as claimed in claim 34, wherein the base material is an electrical insulator.

37. The method as claimed in claim 34, wherein the base material at least in a first region is a semiconductor, an electrical conductivity of which is dependent on the hydrogen content.

38. The method as claimed in claim 34, wherein the hydrogen is implanted into a structural element made from the base material.

39. The method as claimed in claim 38, wherein the hydrogen is implanted into a limited depth region of the structural element.

40. The method as claimed in claim 34, wherein hydrogen is introduced into a first region of the structural element, which adjoins an end face of the structural element, in such a manner that it remains permanently in the first region.

41. A method for altering magnetic properties of a material, the method comprising:
providing a base material that has magnetic properties which alter when hydrogen is introduced into the base material; and
introducing hydrogen into the base material, wherein the magnetic properties of the base material are altered at least in a first region of the base material;
wherein the hydrogen is introduced into a structural element made from the base material by at least one end face of the structural element being exposed to a hydrogen-containing plasma.

42. The method as claimed in claim 41, wherein a first part-face of the end face of the structural element is protected from contact with the hydrogen-containing plasma.

43. The method as claimed in claim 42, wherein a second part-face of the end face of the structural element is exposed to the hydrogen-containing plasma for a period of time.

44. The method as claimed in claim 43, wherein a third part-face of the end face of the structural element is exposed to the hydrogen-containing plasma for a period of time.

45. The method as claimed in claim 44, wherein the period of time for which the third part-face of the end face is exposed to the hydrogen-containing plasma is different than the period of time for which the second part-face of the end face is exposed to the hydrogen-containing plasma.

46. The method as claimed in claim 42, wherein the first part-face of the end face is protected from contact with the hydrogen-containing plasma by a mask.

47. The method as claimed in claim 45, wherein the third part-face of the end face of the structural element is only temporarily protected from contact with the hydrogen-containing plasma by a mask while the second part-face of the end face is being exposed to the hydrogen-containing plasma.

48. The method as claimed in claim 41, wherein the hydrogen is introduced into the structural element in such a way that the hydrogen content in the structural element is inhomogeneous in at least one direction.

49. The method as claimed in claim 41, wherein a magnetically inhomogeneous structure is produced in the structural element by the introduction of hydrogen.

50. The method as claimed in claim 49, wherein the magnetically inhomogeneous structure is produced by the hydrogen being introduced into the structural element by ion beam writing or through a mask.

51. The method as claimed in claim 41, wherein first of all a structural element is produced from a base material with magnetic properties, and wherein the magnetic properties of the base material are subsequently altered in at least a first region by the introduction of the hydrogen.

52. The method as claimed in claim 41, wherein a base material which was originally ferromagnetic is rendered paramagnetic by the introduction of hydrogen into at least a first region.

53. The method as claimed in claim 41, wherein the magnetic properties of a manganese-doped base material, are altered by the introduction of hydrogen.

54. The method as claimed in claim 41, wherein the magnetic anisotropy of the base material is altered by the introduction of hydrogen.

55. The method as claimed in claim 41, wherein complexes of hydrogen or deuterium with atoms of the transition metals or of the rare earths are formed as a result of the introduction of hydrogen.

56. The method as claimed in claim 41, wherein complexes of hydrogen or deuterium with doping atoms are formed as a result of the introduction of hydrogen.

57. The method as claimed in claim 41, wherein a doping that is already present in the base material is counter-doped by the introduction of hydrogen.
